(19) United States
(12) Patent Application Publication
(10) Pub. No.: US 2011/0014539 A1
(43) Pub. Date: Jan. 20, 2011

(54) SOLID OXIDE FUEL CELL

(76) Inventors: Han Wool RYU, Gyunggi-do (KR); Chang Sam Kim, Gyunggi-do (KR); Young Soo Oh, Gyunggi-do (KR); Jae Hyuk Jang, Gyunggi-do (KR); Jong Ho chung, Gyunggi-do (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/549,879

(22) Filed: Aug. 28, 2009

(30) Foreign Application Priority Data
Jul. 15, 2009 (KR) 10-2009-0064502

(51) Int. Cl. H01M 8/10

(52) U.S. Cl. 429/479

(57) ABSTRACT

Disclosed herein is a solid oxide fuel cell comprising a support including hollow porous bodies.

### CROSS REFERENCE TO RELATED APPLICATION

This application claims the benefit of Korean Patent Application No. 10-2009-0064502, filed Jul. 15, 2009, entitled “Solid oxide fuel cell”, which is hereby incorporated by reference in its entirety into this application.

### BACKGROUND OF THE INVENTION

1. Technical Field

The present invention relates to a solid oxide fuel cell.

2. Description of the Related Art

A solid oxide fuel cell (SOFC) uses an oxygen or hydrogen ion-conducting solid oxide as an electrolyte, and operates at the highest temperature (700˜1000° C.) among fuel cells. The solid fuel cell is advantageous in that its structure is simple compared to other fuel cells because its constituents are solid; there is no problem with the loss, replenishment and corrosion of an electrolyte; a precious metal catalyst is not required; and fuel can be easily supplied through direct internal reforming. Further, the solid fuel cell is advantageous in that heat and power generation using waste heat can be performed in combination because of the discharge of high-temperature gas.

Owing to these advantages, advanced countries, such as the U.S.A, Japan and the like, are actively researching solid oxide fuel cells (SOFCs) with a commercialization target for solid oxide fuel cells being early in the 21st century.

Generally, a solid oxide fuel cell includes an oxygen ion-conducting electrolyte layer and a porous cathode and anode disposed at both sides of the oxygen ion-conducting electrolyte layer.

The operating principle of a solid oxide fuel cell is as follows. Oxygen reaches the surface of an electrolyte through a porous cathode, and is then converted into oxygen ions by the reduction of oxygen. The oxygen ions move to a porous anode through the electrolyte, and then react with hydrogen supplied to the porous anode to produce water. In this case, since electrons are generated at the anode and are consumed at the cathode, an electric current flows between the cathode and anode when the two electrodes are interconnected.

It is important to increase the efficiency of such a solid oxide fuel cell by improving the porosity of the porous cathode and anode through which oxygen and hydrogen are transmitted, thereby increasing the transmissivity of oxygen and hydrogen.

Generally, in order to manufacture the porous cathode and anode, a porous material, such as carbon black, is heat-treated and oxidized to form a porous electrode layer. However, such a carbon-based porous material is disadvantageous in that it is harmful to the environment and its pore size and porosity is difficult to accurately control.

In a conventional method of manufacturing a fuel cell support (anode support and cathode support), a method of forming pores in the fuel cell support by mixing a binder, an additive and a carbon black porous material with a matrix material (for example, NiO-YSZ, LSM or LSCF) and then molding the mixture into a porous body and then heat-treating the porous body and then oxidizing the heat-treated porous body at high temperature is being used.

This method is disadvantageous in that it is environmentally harmful because a carbon-based porous body is used as a porous body of a fuel cell support and in that the pore size and porosity of the porous body cannot be easily controlled because it is greatly influenced by external conditions, such as molding pressure and the like, in the molding process. Further, the method is disadvantageous in that it is difficult to obtain desired porosity because it is greatly influenced by a pore forming process depending on heat treatment conditions. That is, the method is disadvantageous in that processes become complicated and long depending on the conditions of molding and heat treatment.

### SUMMARY OF THE INVENTION

Accordingly, the present invention has been made to solve the above-mentioned problems, and the present invention provides a solid oxide fuel cell whose pore size and porosity can be accurately controlled only by adjusting the added amount and size of a porous body without an additional oxidization process while maintaining the shape of the porous body even at high temperature.

Further, the present invention provides a solid oxide fuel cell using an environment-friendly porous body, such as a carbon porous body, which is not required to be oxidized at high temperature.

Furthermore, the present invention provides a solid oxide fuel cell which can use a porous body made of a material identical to a matrix material.

An aspect of the present invention provides a solid oxide fuel cell comprising a support including hollow porous bodies.

Each of the hollow porous bodies may be a ceramic hollow body.

Each of the hollow porous bodies may be made of a material identical to a matrix material of the support, preferably, a ceramic material identical to a matrix material of the support.

Meanwhile, the hollow porous bodies may be formed of different-sized spheres.

The support may further comprise a coating layer thereon.

Here, each of the hollow porous bodies may be made of a material identical to a matrix material of the coating layer, preferably, a ceramic material identical to a matrix material of the coating layer.

Further, the hollow porous bodies may be made of materials identical to a matrix material of the coating layer and a matrix material of the support, more preferably, ceramic materials identical to a matrix material of the coating layer and a matrix material of the support.

The support may be prepared by mixing the matrix material of the support with the hollow porous bodies and then molding the mixture.

The support may be a support for an anode.

The support may be a support for a cathode.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic sectional view showing a support for a solid oxide fuel cell according to an embodiment of the present invention;

FIG. 2 is a schematic view for explaining a method of forming a hollow porous body which can be used in the present invention;

FIG. 3 is a scanning electron microscope (SEM) photograph (×20000) showing a hollow porous body according to an embodiment of the present invention; and

FIG. 4 is a scanning electron microscope (SEM) photograph (×100000) showing the enlarged surface of the hollow porous body shown in FIG. 3.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

Throughout the accompanying drawings, the same reference numerals are used to designate the same or similar components, and redundant descriptions thereof are omitted. In the description of the present invention, when it is anticipated that the detailed description of the related art would obscure the gist of the present invention, the description thereof will be omitted. In the present specification, the terms “first”, “second” and the like are used to differentiate a certain component from other components, but the configuration of such components should not be construed to be limited by the terms.

Hereinafter, preferred embodiments of the present invention will be described in detail with reference to the attached drawings.

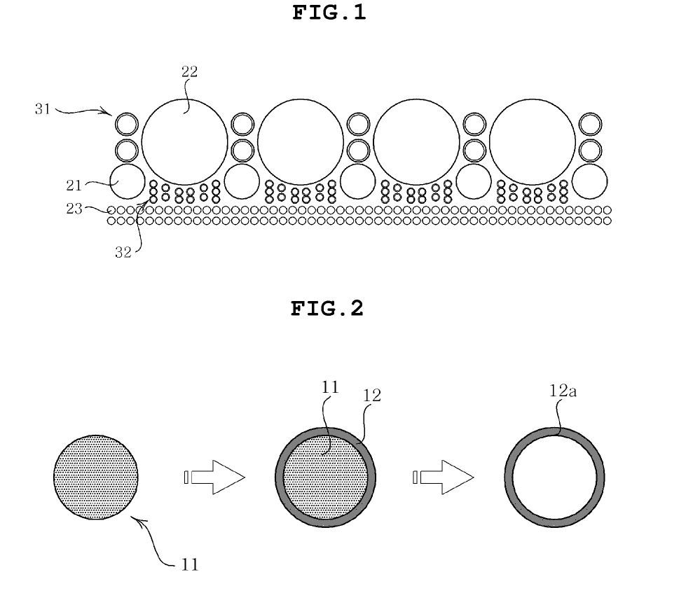

FIG. 1 is a schematic sectional view showing a support for a solid oxide fuel cell according to an embodiment of the present invention.

FIG. 2 is a schematic view for explaining a method of forming a hollow porous body which can be used in the present invention.

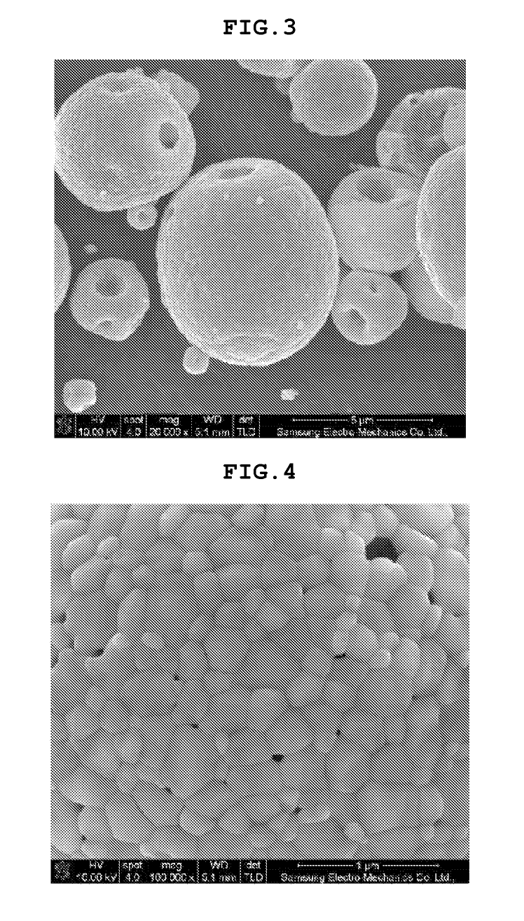

FIG. 3 is a scanning electron microscope (SEM) photograph (×20000) showing a hollow porous body according to an embodiment of the present invention, and FIG. 4 is a scanning electron microscope (SEM) photograph (×100000) showing the enlarged surface of the hollow porous body shown in FIG. 3.

A solid oxide fuel cell according to an embodiment of the present invention comprises a support including hollow porous bodies.

The hollow porous body may be a ceramic hollow body, and may be generally made of a material identical to a matrix material of a support, preferably, a ceramic material identical to a matrix material of a support. Examples of the ceramic material may include, but are not limited to, NiO-YSZ, LaSrMnO₃, LaSrCoFeO₃, LaSrGaMnO, SmCeO₂, GdCeO₂, ZrO₂, ScSZ, ScCeSZ GdCeO₂, LaCrO₃, LaCoO₃ and the like. The ceramic material can be used without limitation as long as it is a material commonly-known in the related field as a matrix material of a support for a solid oxide fuel cell.

The hollow porous bodies may be formed of different-sized spheres.

As such, since the hollow porous bodies are spheres of different sizes, the sizes and contents of the hollow porous bodies included in the support can be adjusted, thus allowing accurate control of the pore size and porosity of the support. Such an advantage follows from the fact that the hollow porous bodies used in the present invention can maintain their shape even at the relatively high temperature which is applied during a general solid oxide fuel cell manufacturing process.

Referring to FIG. 1, matrix materials 21, 22 and 23 of a support and hollow porous bodies 31 and 32 are mixed in an appropriate composition ratio, and then a general high-temperature support molding process is performed, thus allowing the support to include a desired amount of the hollow porous bodies 31 and 32.

In conventional carbon-based porous bodies, after the carbon-based porous bodies are mixed with matrix materials, additional processes for forming porous bodies, such as an oxidization process, a foaming process and the like, must be performed, and the pore size and porosity of the support is determined by the degree of oxidization and/or foaming of the mixture through these additional processes. Therefore, there are problems in that the processes are complicated and in that it is difficult to accurately control the pore size and porosity of the support.

In contrast, in the present invention, since hollow porous bodies, which can maintain their shape even at the relatively high temperature which is applied during a general solid oxide fuel cell manufacturing process, are used, the pore size and porosity of the support can be maintained constant even after the hollow porous bodies are mixed with matrix materials following which the mixture is formed into a support, so that all of the pore characteristics of the support can be controlled to a desired degree by adjusting the size and amount of the hollow porous bodies mixed with the matrix materials.

Hereinafter, a method of forming a hollow porous body according to an embodiment of the present invention will be described in detail with reference to FIG. 2.

First, a spherical precursor 11 is provided. Examples of the precursor 11 may include, but are not limited to, a solid template, a polymer and the like.

Subsequently, a matrix material 12 is applied to the surface of the precursor 11. In this case, an adhesive material, such as silicon, may be selectively applied to the surface of the precursor 11 before the matrix material is applied thereto. The above-mentioned ceramic material, such as NiO-YSZ, LaSrMnO₃, LaSrCoFeO₃, LaSrGaMnO, SmCeO₂, GdCeO₂, ZrO₂, ScSZ, ScCeSZ GdCeO₂, LaCrO₃, LaCoO₃ or the like, may be used as the matrix material 12, but the present invention is not limited thereto. Further, the matrix material 12 can be applied to the surface of the precursor 11 using a slip coating method or a plasma spray coating method, but the present invention is not limited thereto.

Finally, the precursor 11 is removed through high-temperature heat treatment to obtain a hollow porous body 12a.

FIG. 3 shows a scanning electron microscope (SEM) photograph (×20000) of the above-obtained hollow porous body.

Referring to FIG. 3, a precursor formed in a spherical body comes to the outside of the spherical body to form pores, thereby forming a hollow porous body.

FIG. 4 is a scanning electron microscope (SEM) photograph (×100000) showing the enlarged surface of the hollow porous body shown in FIG. 3. From FIG. 4, it can be seen that strong bonding structures are formed and that pores of a variety of different shapes are formed.

The support including the hollow porous bodies may be used as a support for either an anode or a cathode.

Generally, a solid oxide fuel cell includes an electrolyte layer, an anode layer formed on one side of the electrolyte layer, a cathode layer formed on the other side of the electrolyte layer, and a support serving to support electrode layers including the anode and cathode layers and to supply gas (fuel or air). The solid oxide fuel cell may further include a coating layer between the support and the electrode layers in order to make up for the support.

The anode layer receives the fuel penetrating the support and generates an electric current. Thereafter, the generated electric current is accumulated, and thus electrical energy is supplied to an external circuit. The anode layer can be formed by coating a metal bar with a ceramic material, such as NiO-YSZ (Yttria stabilized Zirconia), using a slip coating method or a plasma spray coating method and then heating the metal bar coated with the ceramic material to a temperature of 1200˜1300° C., but the present invention is not limited thereto.

The electrolyte layer is formed between the anode layer and the cathode layer. Electric current does not pass through the electrolyte layer, and the electrolyte layer transmits only hydrogen ions to the cathode layer in the case of using hydrogen as fuel. The electrolyte layer can be formed by coating YSZ (yttria stabilized zirconia), ScSZ (scandium stabilized zirconia), GDC, LDC or the like using a slip coating method or a plasma spray coating method and then sintering the coated material at a temperature of 1300˜1500° C., but the present invention is not limited thereto.

The cathode layer serves to produce water by bonding hydrogen ions transferred from the electrolyte with electrons transferred through an external circuit and oxygen in the air. The cathode layer can be formed by coating a metal bar with LSM (strontium doped lanthanum manganite), LSCF ((La,Sr)(Co,Fe)O₃) or the like using a slip coating method or a plasma spray coating method and then sintering the metal bar coated with the coating material at a temperature of 1200˜1300° C., but the present invention is not limited thereto.

Meanwhile, the coating layer serves to support the anode layer, and is formed between the support and the electrode layers. The coating layer must be porous in order to allow gas to be transmitted therethrough. The coating layer may be made of the same matrix material as the support. The above-mentioned hollow porous body may be made of the same material as the matrix material of the coating layer.

Preferably, the coating layer may be made of a ceramic material, such as, NiO-YSZ, LaSrMnO₃, LaSrCoFeO₃, LaSrGaMnO, SmCeO₂, GdCeO₂, ZrO₂, ScSZ, ScCeSZ GdCeO₂, LaCrO₃, LaCoO₃ or the like. Any ceramic material can be used without limitation as long as it is a material commonly-known in the related field as a matrix material of a support for a solid oxide fuel cell.

As described above, the present invention is advantageous in that a hollow porous body which can maintain its shape even at high temperature is used instead of a conventional carbon-based porous body, so that the amount and size of the hollow porous body mixed with a matrix material of a support can be adjusted, thereby providing accurate control of the pore size and porosity of the support.

Further, the present invention is advantageous in that it is environment-friendly because a porous body having the same quality as a matrix material is used, and in that a heat treatment process can be simplified because an oxidization process is not required.

Further, the present invention is advantageous in that since a hollow porous body which can maintain its shape even at high temperature is used, the amount and size of the hollow porous body can be adjusted, so that the pore size and porosity of the support can be accurately controlled, with the result that gas transmission is improved and fuel use and ion conduction efficiencies are increased, thereby improving the performance of a fuel cell.

Furthermore, the present invention is advantageous in that a material harmful to the environment, such as carbon, can be replaced and processes can be made more friendly to the environment because a material having the same quality as a matrix material can be used, and in that a heat treatment process can be simplified because a process for maintaining a carbon porous body at a high temperature for a long time and thus oxidizing the carbon porous body is not required.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

Simple modifications, additions and substitutions of the present invention belong to the scope of the present invention, and the specific scope of the present invention will be clearly defined by the appended claims.

What is claimed is:

1. A solid oxide fuel cell comprising a support including hollow porous bodies.

2. The solid oxide fuel cell according to claim 1, wherein each of the hollow porous bodies is a ceramic hollow body.

3. The solid oxide fuel cell according to claim 1, wherein each of the hollow porous bodies is made of a material identical to a matrix material of the support.

4. The solid oxide fuel cell according to claim 1, wherein each of the hollow porous bodies is made of a ceramic material identical to a matrix material of the support.

5. The solid oxide fuel cell according to claim 1, wherein the hollow porous bodies are formed of different-sized spheres.

6. The solid oxide fuel cell according to claim 1, wherein the support further comprises a coating layer thereon.

7. The solid oxide fuel cell according to claim 6, wherein each of the hollow porous bodies is made of a material identical to a matrix material of the coating layer.

8. The solid oxide fuel cell according to claim 6, wherein each of the hollow porous bodies is made of a ceramic material identical to a matrix material of the coating layer.

9. The solid oxide fuel cell according to claim 6, wherein the hollow porous bodies are made of materials identical to a matrix material of the coating layer and a matrix material of the support.

10. The solid oxide fuel cell according to claim 6, wherein the hollow porous bodies are made of ceramic materials identical to a matrix material of the coating layer and a matrix material of the support.

11. The solid oxide fuel cell according to claim 1, wherein the support is prepared by mixing the matrix material of the support with the hollow porous bodies and then molding the mixture.

12. The solid oxide fuel cell according to claim 1, wherein the support is a support for an anode.

13. The solid oxide fuel cell according to claim 1, wherein the support is a support for a cathode.
